(19) United States
(12) Patent Application Publication
(10) Pub. No.: US 2016/0075166 A1
(43) Pub. Date: Mar. 17, 2016

(54) PROCESSES FOR PRODUCING SECURITY THREADS OR STRIPES

(71) Applicant: SICPA HOLDING SA, Prilly (CH)

(72) Inventors: Gebhard RITTER, Lausanne (CH); Xiang LI, Beijing (CN); Mathieu SCHMID, Lausanne (CH); Pierre DEGOTT, Crissier (CH)

(73) Assignee: SICPA HOLDING SA, Prilly (CH)

(21) Appl. No.: 14/888,266

(22) PCT Filed: Apr. 24, 2014
(86) PCT No.: PCT/EP2014/058327

§ 371 Date: Oct. 30, 2015

(30) Foreign Application Priority Data
May 2, 2013 (EP) 13166225.6

(51) Int. Cl. B42D 25/355

(52) U.S. Cl. CPC B42D 25/355

(57) ABSTRACT

The present invention relates to the field of the protection of value documents and value commercial goods against counterfeit and illegal reproduction. In particular, the present invention relates to processes for producing security threads or stripes to be incorporated into or onto security documents and security documents comprising said security threads or stripes. The disclosed security threads or stripes comprise a first plurality of magnetic or magnetizable pigment particles having an orientation following a convex curvature when viewed from the side where the first hardened coating and the second hardened coating are at least partially jointly visible and a second hardened coating comprising the second plurality of magnetic or magnetizable pigment particles having an orientation following a concave curvature when viewed from the side of the security thread or stripe where the first hardened coating and the second hardened coating are at least partially jointly visible so as to form a plural rolling bar effect.

### FIELD OF THE INVENTION

The present invention relates to the field of the protection of value documents and value commercial goods against counterfeit and illegal reproduction. In particular, the present invention relates to a process for producing security threads or stripes to be incorporated into or onto security documents, said security threads or stripes exhibiting a dynamic visual motion effect upon tilting.

### BACKGROUND OF THE INVENTION

With the constantly improving quality of color photocopies and printings and in an attempt to protect security documents such as banknotes, value documents or cards, transportation tickets or cards, tax banderols, and product labels against counterfeiting, falsifying or illegal reproduction, it has been the conventional practice to incorporate various security means in these documents. Typical examples of security means include security threads or stripes, windows, fibers, planchettes, foils, decals, holograms, watermarks, security inks or compositions comprising optically variable pigments, magnetic or magnetizable thin film interference pigments, interference-coated particles, thermochromic pigments, photochromic pigments, luminescent, infrared-absorbing, ultraviolet-absorbing or magnetic compounds.

Security threads embedded in the substrate are known to those skilled in the art as an efficient means for the protection of security documents and banknotes against imitation. Reference is made to U.S. Pat. No. 0,964,014; U.S. Pat. No. 4,652,015; U.S. Pat. No. 5,068,008; U.S. Pat. No. 5,324,079; WO 90/08367 A1; WO 92/11142 A1; WO 96/04143 A1; WO 96/39685 A1; WO 98/19866 A1; EP 0 021 350 A1; EP 0 185 396 A2; EP 0 303 725 A1; EP 0 319 157 A2, EP 0 518 740 A1; EP 0 608 078 A1; and EP 1 498 545 A1 as well as the references cited therein. A security thread is a metal- or plastic-filament, which is incorporated during the manufacturing process into the substrate serving for printing security documents or banknotes. Security threads or stripes carry particular security elements, serving for the public- and/or machine-authentication of the security document, in particular for banknotes. Suitable security elements for such purpose include without limitation metallizations, optically variable compounds, luminescent compounds, micro-texts and magnetic features.

With the aim of protecting value documents such as banknotes from being forged, optically variable security threads or stripes exhibiting color shift or color change upon variation of the angle of observation have been proposed as security features to be incorporated into or onto said value documents. The protection from forgery is based on the variable color effect that optically variable security elements convey to the viewer in dependence on the viewing angle or direction.

In addition to static security features used for protecting security documents against counterfeit and illegal reproduction, dynamic security features providing the optical illusion of movement have been developed. In particular, security elements based on oriented magnetic or magnetizable pigments and magnetic or magnetizable optically variable pigments have been developed so as to provide an optical illusion of movement.

U.S. Pat. No. 7,047,883 discloses the creation of a dynamic optically variable effect known as the “rolling bar” feature. The “rolling bar” feature provides the optical illusion of movement to images comprised of oriented magnetic or magnetizable pigments. U.S. Pat. No. 7,517,578 and WO 2012/104098 A1 respectively disclose “double rolling bar” and “triple rolling bar” features, said features seeming to move against each other upon tilting. A printed “rolling bar” type image shows one or contrasting bands which appear to move (“roll”) as the image is tilted with respect to the viewing angle. Such images are known to be easily recognized by the man on the street and the illusive aspect cannot be reproduced by commonly available office equipment for color scanning, printing and copying. “Rolling bar” features are based on a specific orientation of magnetic or magnetizable pigments. In particular, the magnetic or magnetizable pigments are aligned in a curving fashion, either following a convex curvature (also referred in the art as negative curved orientation) or a concave curvature (also referred in the art as positive curved orientation).

WO 2012/104098 A2 discloses a method for producing “triple rolling bar” features, said method comprising the steps of: a) applying a coating composition comprising magnetic or magnetizable pigment particles onto a substrate; b) orienting said magnetic or magnetizable pigment particles according to a first curved surface by applying a first magnetic field; c) selectively hardening said applied coating composition in first areas, hereby fixing the magnetic pigment particles in their positions and orientations; d) orienting said magnetic or magnetizable pigment particles in the unhardened part of the coating composition according to a second curved surface by applying a second magnetic field; e) hardening said applied coating composition in second areas, hereby fixing the magnetic pigment particles in their positions and orientations. For achieving an area comprising pigments particles oriented to follow a negative curvature and a area comprising pigments particles oriented to follow a positive curvature, the disclosed method requires on one hand to orient the pigments particles by applying a magnet from the bottom of the substrate and, on the other hand, by applying a magnet from the top of the substrate.

However, disclosed methods to obtain a security element comprising a substrate and combining at least two areas, one area comprising magnetic or magnetizable pigment particles oriented so as to follow a negative curvature and another area comprising magnetic or magnetizable oriented to follow a positive curvature require a step of applying a magnet device from above the substrate, i.e. the magnetic device faces the not yet hardened composition comprising the magnetic or magnetizable pigment particles, therefore increasing the complexity of the overall manufacturing process of the security element. For example, the not yet hardened composition should not be placed in direct contact with the magnetic device so as to avoid exclude any deterioration of the optical effect. Moreover, since the strength of a magnetic field decreases rapidly with distance, if the magnetic device is positioned at a large distance from the not yet hardened composition to avoid direct contact, the orientable pigment particles will be oriented by a weaker magnetic field resulting in a less striking optical effect.

There is therefore a need for a simpler and more efficient process for producing highly dynamic security threads or stripes.

### SUMMARY

Accordingly, it is an object of the present invention to overcome the deficiencies of the prior art as discussed above. This is achieved by the provision of a process for producing a security thread or stripe comprising a step of laminating a first structure comprising a transparent substrate and a first plurality of magnetic or magnetizable pigment particles, said pigment particles being dispersed in a first hardened coating and oriented so as to exhibit a rolling bar effect rolling in a first direction when viewed from the side carrying the first hardened coating, with a second structure comprising a transparent substrate and a second plurality of magnetic or magnetizable pigment particles, said pigment particles being dispersed in a second hardened coating and oriented so as to exhibit a rolling bar effect rolling in the first direction when viewed from the side carrying the second hardened coating, so that the transparent substrates face the environment and that the first hardened coating and second hardened coating are comprised between the transparent substrates so as to form a laminated structure, wherein the first hardened coating and the second hardened coating are at least partially jointly visible from one side of the security thread or stripe, so as to exhibit an effect of rolling bars rolling in opposite directions. In particular, the process for producing a security thread or stripe comprises a step of laminating a first structure comprising a transparent substrate and a first plurality of magnetic or magnetizable pigment particles, said pigment particles being dispersed in a first hardened coating and oriented so as to follow a convex curvature when viewed from the side carrying the first hardened coating, with a second structure comprising a transparent substrate and a second plurality of magnetic or magnetizable pigment particles, said pigment particles being dispersed in a second hardened coating and oriented so as to follow a convex curvature when viewed from the side carrying the second hardened coating, so that the transparent substrates face the environment and that the first hardened coating and second hardened coating are comprised between the transparent substrates so as to form a laminated structure, wherein the first hardened coating and the second hardened coating are adjacent to each other or are spaced apart, wherein the first hardened coating and the second hardened coating are at least partially jointly visible from one side of the security thread or stripe, and wherein the laminated structure comprises the first hardened coating comprising the first plurality of magnetic or magnetizable pigment particles having an orientation following a convex curvature when viewed from the side of the security thread or stripe where the first hardened coating and the second hardened coating are at least partially jointly visible and the second hardened coating comprising the second plurality of magnetic or magnetizable pigment particles having an orientation following a concave curvature when viewed from the side of the security thread or stripe where the first hardened coating and the second hardened coating are at least partially jointly visible so as to form a plural rolling bar effect.

Also described herein are security threads or stripes obtained by the process described herein.

In an embodiment, there is provided a step of slicing the laminated structure to produce a plurality of security threads or stripes exhibiting the effect of rolling bars rolling in opposed directions.
In an embodiment, the process comprises a step of applying one or more adhesive layers on the first structure and/or on the second structure to adhere the first and second structures together in the laminated structure.
In an embodiment, the process comprises flipping the first structure relative to the second structure and laminating the structures in the relatively flipped orientation.
In an embodiment, at least one of the first and second structures has a rolling bar effect portion and a rolling bar effect free portion and the first and second structures are laminated so that the rolling bar effect free portion of one of the structures overlays a rolling bar effect portion of the other of the first and second structures.
In an embodiment, the process comprises providing a pre-structure exhibiting an effect of one or more rolling bars rolling in the first direction, cutting the pre-structure to provide the first and second substrates and relatively flipping the first and second substrates so that the first and second substrates exhibit an effect of rolling bars rolling in the same direction prior to flipping and exhibit an effect of rolling bars rolling in opposite directions in the relatively flipped orientation.
In an embodiment, a plurality of spaced apart stripes of magnetic or magnetizable particle oriented for exhibiting a rolling bar effect are provided on at least one of the first and second substrates.

In an embodiment, the process comprises providing the first and second substrates with a plurality of spaced apart stripes of magnetic or magnetizable particles oriented for exhibiting a rolling bar effect and laminating them together with the stripes in an offset position so that the stripes of one of the substrates are positioned in alignment with the spaces between the stripes of the other of the substrates.

Also described and claimed herein are security threads or stripes comprising the laminated structure, the laminated structure comprising a first structure and a second structure, the first and second structures each comprising a transparent substrate and a plurality of magnetic or magnetizable pigment particles, said pigment particles being dispersed in a hardened coating and oriented for exhibiting a rolling bar effect, wherein the transparent substrates face outwardly in the laminated structure and the hardened coatings of the first and second structures are comprised between the transparent substrates in the laminated structure, wherein the first or the second structure has a portion free of coating through which the underlying oriented magnetic or magnetizable pigment particles of the other of the first or the second structures can be viewed from one side of the security thread or stripe such that rolling bar effects provided by the oriented pigment particles of the first structure and the second structure are jointly visible from the one side of the security thread or stripe, the joint effect being that of rolling bars respectively provided by the first and second structures rolling in opposite directions when the thread or stripe is tilted.

Also described and claimed therein are uses of the security threads or stripes described herein for the protection of a security document against counterfeiting or fraud.

Also described and claimed therein are security documents comprising the security thread or stripe described herein, said security thread or stripe being at least partially embedded in said security document or said security thread or stripe is mounted on the surface of the security document. Also described herein are processes for producing a security document and security documents obtained or produced thereof.

Also described herein are processes for producing a security document and security documents obtained or produced thereof. Said processes for producing a security document comprising a security thread or stripe comprise the steps of i) producing the security thread or stripe by the process described herein, and ii) at least partially embedding in said security document the security thread or stripe obtained under step i) or a step of mounting the security thread or stripe obtained under step i) on the surface of the security document.

### BRIEF DESCRIPTION OF DRAWINGS

FIG. 1A-B schematically illustrate top views of a security thread exhibiting a double rolling bar effect upon tilting.

FIG. 1C-D schematically illustrate top views of a security thread exhibiting a double rolling bar effect upon tilting.

FIG. 2A schematically illustrates magnetic or magnetizable pigment particles orientation following a negative curve (convex orientation) when viewed from the side carrying the hardened coating.

FIG. 2B schematically illustrates magnetic or magnetizable pigment particles orientation following a positive curve (concave orientation) when viewed from the side carrying the hardened coating.

FIG. 2C schematically illustrates a magnetic-field generating device suitable for forming a magnetic field in a convex fashion or a concave fashion as a function of its position.

FIG. 3 A-B schematically illustrate laminating processes for producing security threads or stripes according to the present invention.

FIG. 4A-4D schematically illustrate top views of security threads exhibiting a double rolling bar effect (4A), a triple rolling bar effect (4B), a plural rolling bar effect (4C) either in the form of stripes (4A-4C) or indicia (4D).

### DETAILED DESCRIPTION

The following definitions are to be used to interpret the meaning of the terms discussed in the description and recited in the claims.

As used herein, the article “a” indicates one as well as more than one and does not necessarily limit its referent noun to the singular.

As used herein, the term “about” in conjunction with an amount or value means that the amount or value in question may be the specific value designated or some other value in its neighborhood. Generally, the term “about” denoting a certain value is intended to denote a range within ±5% of the value. As one example, the phrase “about 100” denotes a range of 100±5, i.e. the range from 95 to 105. Preferably, the range denoted by the term “about” denotes a range within ±3% of the value, more preferably ±1%. Generally, when the term “about” is used, it can be expected that similar results or effects according to the invention can be obtained within a range of ±5% of the indicated value.

As used herein, the term “and/or” means that either all or only one of the elements of said group may be present. For example, “A and/or B” shall mean “only A, or only B, or both A and B”. In the case of “only A”, the term also covers the possibility that B is absent, i.e. “only A, but not B”. In case of “only B”, the term also covers the possibility that A is absent, i.e. “only B, but not A”.

As used herein, the term “at east” is meant to define one or more than one, for example one or two or three.

The term “comprising” as used herein is intended to be non-exclusive and open-ended. Thus, for instance a composition comprising a compound A may include other compounds besides A.

The term “coating composition” refers to liquid or slurry which is capable of forming a layer or a coating on a solid substrate and which can be applied preferentially but not exclusively by a coating or printing method. The coating compositions described herein comprise a plurality magnetic or magnetizable pigment particles and a binder material.

The term “hardened” means that the magnetic or magnetizable pigment particles are fixed in their respective positions and orientations within a coating.

As used herein, the term “indicia” shall mean discontinuous layers such as patterns, including without limitation symbols, alphanumeric symbols, motifs, letters, words, numbers, logos and drawings.

A thread or stripe consists of an elongated security element. By “elongated”, it is meant that the dimension of the security element in the longitudinal direction is more than twice as large as its dimension in the transverse direction.

As used herein, the term “pigment” is to be understood according to the definition given in DIN 55943: 1993-11 and DIN EN 971-1: 1996-09. Pigments are materials in powder or flake form which are—contrary to dyes—not soluble in the surrounding medium.

As used herein, the terms “convex” and “concave” when related to the security thread or stripe described herein are always in reference with the observation view from the side of the security thread or stripe where the first hardened coating and the second hardened coating are at least partially jointly visible.

As used herein, the terms “convex” and “concave” when related to the first structure and the second structure described herein are always in reference with the observation view from the side of the structure carrying the hardened coating.

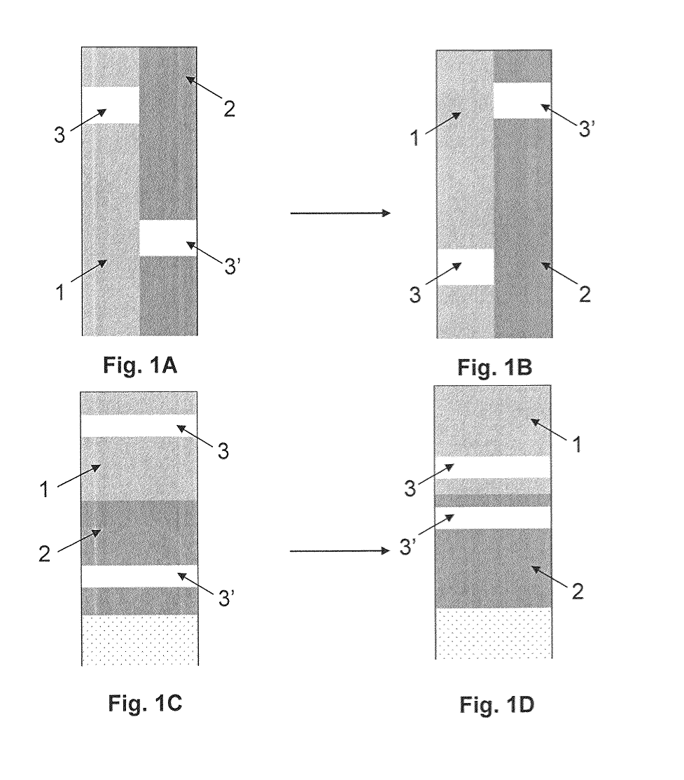

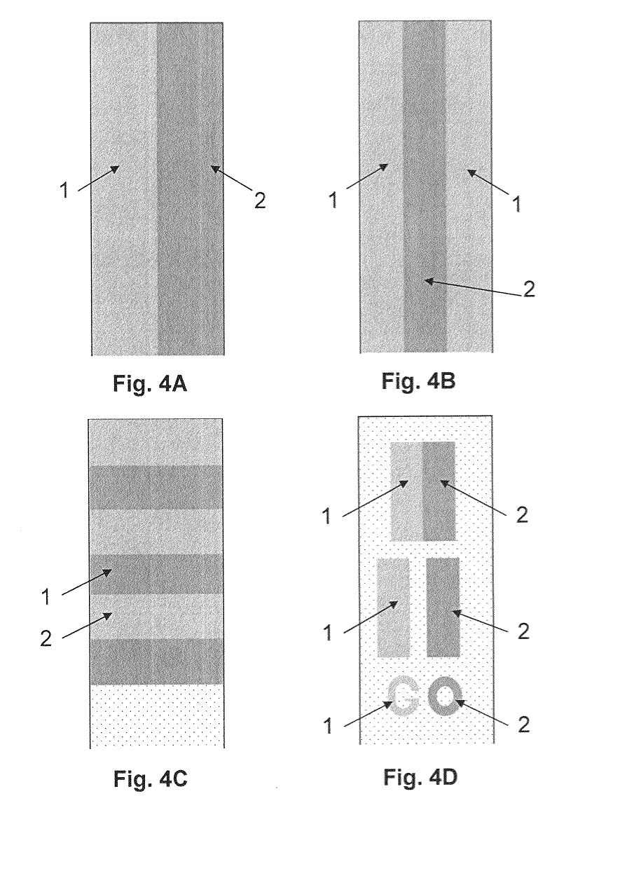

The present invention provides a process for producing security threads or stripes consisting of laminated structures comprising two transparent substrates enclosing at least two areas, said at least two areas consisting of two hardened coatings comprising oriented magnetic or magnetizable pigment particles and reflecting light in different directions. In particular, it provides a process for producing security threads or stripes exhibiting a plural rolling bar effect and security threads or stripes obtained therefrom. According to one embodiment, the present invention provides a process for producing security threads or stripes comprising two areas, i.e. two hardened coatings, exhibiting a rolling bar effect (also referred as double rolling bar effect), wherein the rolling bar effect of one area is different from the rolling bar effect of the other area in terms of rolling effect (see for example FIG. 1A-D, FIG. 4A and FIG. 4D, wherein the security thread comprises a first hardened coating (1) and a second hardened coating (2) having opposite rolling bar effects). According to another embodiment, the present invention provides a process for producing security threads or stripes comprising three areas, i.e. three hardened coatings exhibiting a rolling bar effect (also referred as triple rolling bar effect), wherein the rolling bar effect of one area is different from the rolling bar effect of the two other areas (see for example FIG. 4B, wherein the security thread comprises two first hardened coatings (1) and a second hardened coating (2), said first and second coating having opposite rolling bar effects). According to another embodiment, the present invention provides a process for producing security threads or stripes comprising more than three areas, i.e. more than three hardened coatings, exhibiting a rolling bar effect, wherein the rolling bar effect of one area is different from the rolling bar effect of the other areas. The present invention provides a simpler and more efficient process for producing highly dynamic security threads or stripes in comparison with the prior art. The security threads or stripes obtained therefrom exhibit a highly dynamic appearance when tilted.

FIGS. 1A-D illustrate top views of security threads or stripes exhibiting a double rolling bar effect, said double rolling bar effect being obtained by the combination of a first hardened coating (1) and a second hardened coating (2) exhibiting two different rolling effects, said first and second hardened coatings comprising oriented magnetic or magnetizable pigment particles. As with the tilt of the security thread or stripe with respect to the viewing angle (illustrated by an arrow in FIGS. 1A-D), two light bands or bars (3, 3′) appear to move or roll across the security thread or stripe in opposite directions.

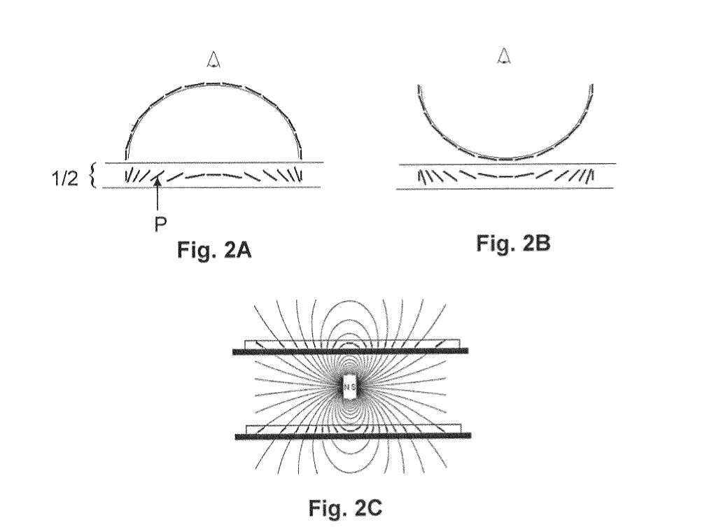

As mentioned hereabove, “rolling bar” effects or features are based on a specific orientation of magnetic or magnetizable pigment particles in a hardened coating on a substrate. Magnetic or magnetizable pigments particles in a binder material are aligned in an arching pattern relative to a surface of the substrate so as to create a contrasting bar across the image said contrasting bar appearing to move as the image is tilted relative to a viewing angle. In particular, the magnetic or magnetizable pigment particles are aligned in a curving fashion, either following a convex curvature (also referred in the art as negative curved orientation, see FIG. 2A) or a concave curvature (also referred in the art as positive curved orientation, see FIG. 2A). A hardened coating comprising pigment particles having an orientation following a convex curvature (negative curved orientation) shows a visual effect characterized by a downward movement of the rolling bar when the security thread or stripe is tilted backwards (i.e. the top of the security thread or stripe moves away from the observer while the bottom of the security thread or stripe moves towards from the observer). A hardened coating comprising pigment particles having an orientation following a concave curvature (positive curved orientation) shows a visual effect characterized by an upward movement of the rolling bar when the security thread or stripe is tilted backwards.

As described in the prior art, for example in U.S. Pat. No. 7,047,888, U.S. Pat. No. 7,517,578 and WO 2012/104098 A1 and as illustrated in FIG. 2C, known methods to obtain on a substrate a magnetic or magnetizable pigment particles orientation following a negative curve (convex curvature when viewed from the side carrying the hardened coating, illustrated by an eye, see FIG. 2A) include the use of a magnetic device to orient the pigment particles, said device being placed underneath the substrate (FIG. 2C, top). To obtain on a substrate a magnetic or magnetizable pigment particles orientation following a positive curve (concave curvature when viewed from the side carrying the hardened coating, illustrated by an eye, see FIG. 2B), the magnetic device used to orient the pigment particles is placed above the substrate (FIG. 2C, below), i.e. the magnetic device faces the coating comprising the magnetic or magnetizable pigment particles. In FIGS. 1A-D, the first hardened coating (1) and the second hardened coating (2) exhibit two different rolling effects, i.e. one of said hardened coatings comprises magnetic or magnetizable pigment particles having an orientation following a convex curvature when viewed from the side carrying the hardened coating and the other coating comprises magnetic or magnetizable pigment particles having an orientation following a concave curvature when viewed from the side carrying the hardened coating. However and as mentioned hereabove, orienting magnetic or magnetizable pigment particles by applying a magnetic-field-generating device from the side facing the magnetic or magnetizable pigment particles strongly increases the complexity of the overall manufacturing process.

The process for producing a security thread or stripe according to the present invention comprises a step of laminating a first structure comprising a transparent substrate and a first plurality of magnetic or magnetizable pigment particles, said pigment particles being dispersed in a first hardened coating and oriented so as to follow a convex curvature when viewed from the side carrying the first hardened coating with a second structure comprising a transparent substrate and a second plurality of magnetic or magnetizable pigment particles, said pigment particles being dispersed in a second hardened coating and oriented so as to follow a convex curvature when viewed from the side carrying the second hardened coating, said laminating step being performed in such a way that the transparent substrates face the environment and that the first hardened coating and second hardened coating are comprised between the transparent substrates so as to form a laminated structure.

The process for producing a security thread or stripe according to the present invention comprises a step of laminating the first structure with the second structure so that the transparent substrate faces the environment and so that the first hardened coating and the second hardened coating are comprised between the transparent substrates so as to form a laminated structure. The laminating step is performed by a conventional lamination process known in the art such as for example a processes consisting of applying heat and/or pressure on the first and second structure optionally further comprising an additional material present at least one of the surface to be bonded. Typically, the additional material consists of a conventional lamination adhesive layer or a conventional tie layer which may be water-based, solvent-based, solvent-free or UV-curable compositions. In an embodiment, the process comprises a step of applying one or more adhesive layers on the first structure and/or on the second structure to adhere the first and second structures together in the laminated structure.

The laminating step is performed so as to obtain a security thread or stripe comprising a first hardened coating comprising the first plurality of magnetic or magnetizable pigment particles having an orientation following a convex curvature when viewed from the side of the security thread or stripe where the first hardened coating and the second hardened coating are at least partially jointly visible and a second hardened coating comprising the second plurality of magnetic or magnetizable pigment particles having an orientation following a concave curvature when viewed from the side of the security thread or stripe where the first hardened coating and the second hardened coating are at least partially jointly visible so as the security thread or stripe described herein exhibit a plural rolling bar effect; the first hardened coating and the second hardened coating being at least partially jointly visible from one side of the security thread or stripe. By “jointly visible”, it is meant that the first and second hardened coatings are visible as a combination, producing thereby a highly dynamic effect.

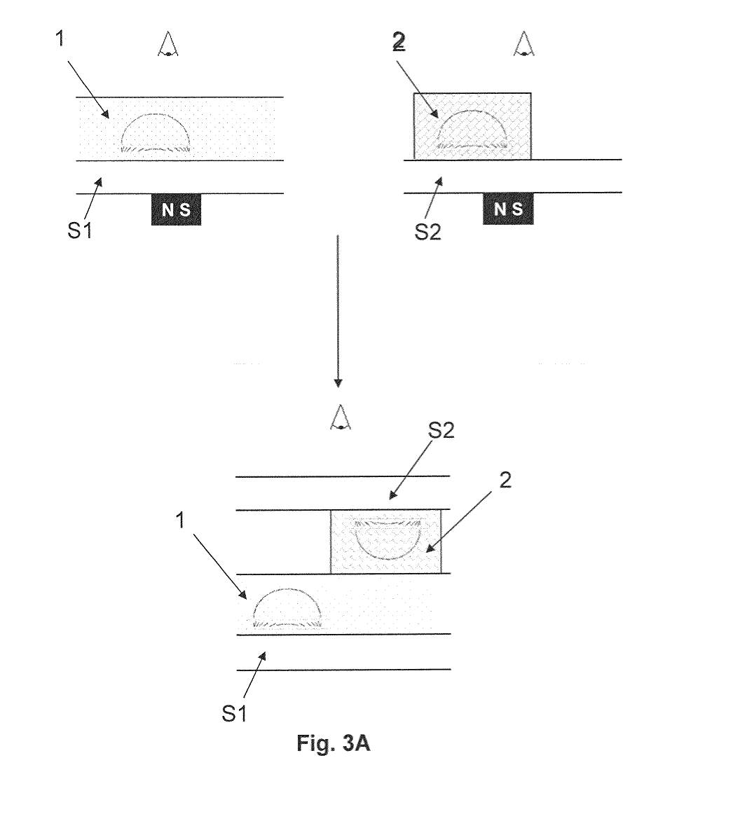

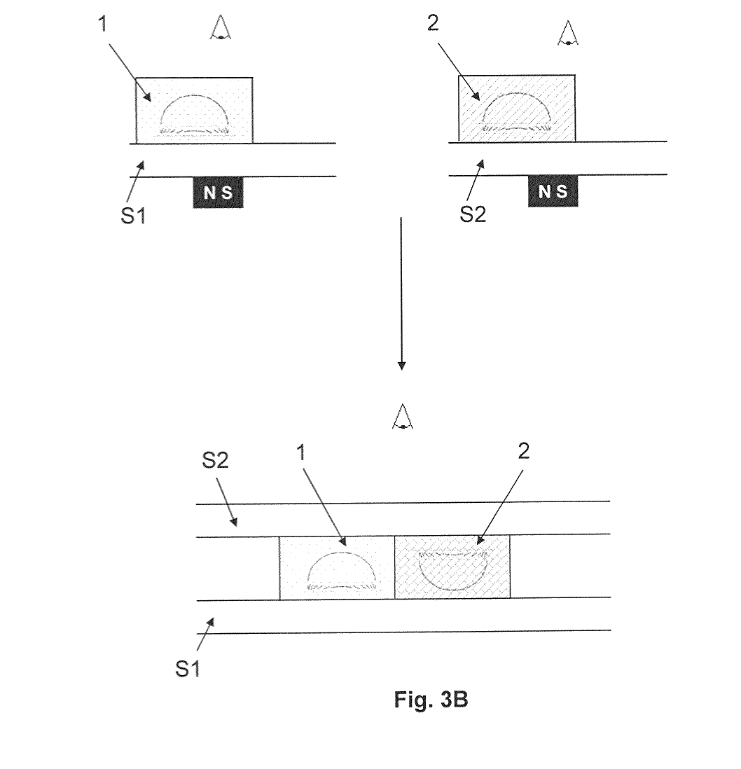

The first structure comprises a transparent substrate and a first hardened coating and the second structure comprises a transparent substrate and a second hardened coating, said transparent substrates being the same or being different and said first and second hardened coating being the same or different, exhibit a same rolling bar effect (convex curvature) when viewed from the side carrying the hardened coating. After laminating the first structure with the second structure in such a way (see for example FIGS. 3A-B) that both hardened coatings are comprised between the transparent substrates and that the first plurality of magnetic or magnetizable pigment particles have an orientation following a convex curvature when viewed from the side of the security thread or stripe where the first hardened coating and the second hardened coating are at least partially jointly visible and the second hardened coating comprising the second plurality of magnetic or magnetizable pigment particles having an orientation following a concave curvature when viewed from the side of the security thread or stripe where the first hardened coating and the second hardened coating are at least partially jointly visible, a security thread or stripe exhibiting a plural rolling bar effect is obtained.

In an embodiment, the process comprises flipping the first structure relative to the second structure and laminating the structures in the relatively flipped orientation.

As shown in FIG. 3A (top), the first structure comprising a transparent substrate (S1) and a first hardened coating (1) and the second structure comprising a transparent substrate (S2) and a second hardened coating (2), said transparent substrates (S1 and S2) being the same or being different and said first and second hardened coatings (1 and 2) being the same or different, exhibit a same rolling bar effect (convex curvature) when viewed from the side carrying the hardened coating (illustrated by an eye). The first hardening coating (1) covers the whole surface of the transparent substrate (S1) while the second hardened coating (2) covers only a part of the transparent substrate (S2), so that areas of the transparent substrate (S2) are left blank. After laminating the first structure with the second structure in such a way that both hardened coatings (1 and 2) are comprised between the transparent substrates (S1 and S2), the first hardened coating (1), as seen through the blank areas on coating exhibits the same rolling bar effect (convex curvature) as before lamination whereas the second hardened coating (2) exhibits the opposite rolling bar effect (concave curvature).

As shown in FIG. 3B (top), the first structure comprising a transparent substrate (S1) and a first hardened coating (1) and the second structure comprising a transparent substrate (S2) and a second hardened coating (2), said transparent substrates (S1 and S2) being the same or being different and said first and second hardened coatings (1 and 2) being the same or different, exhibit a same rolling bar effect (convex curvature) when viewed from the side carrying the hardened coating (illustrated by an eye). The first hardening coating (1) covers only a part of substrate of the transparent substrate (S1) so that areas of the transparent substrate (S1) are left blank and the second hardened coating (2) covers as well only a part of the transparent substrate (82), so that areas of the transparent substrate (S2) are left blank. After laminating the first structure with the second structure in such a way that both hardened coatings (1 and 2) are comprised between the transparent substrates (S1 and S2), the first hardened coating (1) exhibits the same rolling bar effect (convex curvature) as before lamination whereas the second hardened coating (2) exhibits the opposite rolling bar effect (concave curvature). The terms “concave” and convex” always refer to the observation view (see eyes in FIGS. 3A-B).

According to one embodiment of the present invention, the first structure and the second structure are independently prepared by a step of a) applying, preferably by a coating or a printing process and more preferably by a printing process selected from the group consisting of rotogravure, screen printing and flexography, on a transparent substrate a coating composition comprising a binder material and a plurality of magnetic or magnetizable pigment particles, b) exposing the coating composition in a first state to a magnetic field of a magnetic-field-generating device and c) hardening the coating composition to a second state so as to fix the magnetic or magnetizable pigment particles in their adopted positions and orientations so as to obtain a first structure comprising a first hardened coating on a transparent substrate and a second structure comprising a second hardened coating on a transparent substrate.

According to another embodiment of the present invention, the first structure and the second structure are produced from a pre-structure prepared by a) a step of applying, preferably by a coating or a printing process and more preferably by a printing process selected from the group consisting of rotogravure, screen printing and flexography, on a transparent substrate a coating composition comprising a binder material and the plurality of magnetic or magnetizable pigment particles, b) exposing the coating composition in a first state to the magnetic field of a magnetic-field-generating device, and c) hardening the coating composition to a second state so as to fix the magnetic or magnetizable pigment particles in their adopted positions and orientations so as to obtain a hardened coating and d) cutting the pre-structure obtained under step c) so as to obtain a first structure and a second structure. The pre-structure can be cut in a cross-machine direction or in machine direction and preferably in machine direction.

In an embodiment, the process comprises feeding a pre-structure comprising a transparent substrate and oriented magnetic or magnetizable pigment particles dispersed in a hardened coating disposed on the transparent substrate and cutting the pre-structure to provide the first and second structures. The feeding is in a machine direction and the cutting is either in a cross-machine direction or in machine direction, preferably in machine direction. The process comprises relatively flipping the first or second structure and laminating them together in the relatively flipped orientation.

In an embodiment, the first structure and the second structure are produced from a pre-structure prepared by a) a step of applying, preferably by a coating or a printing process and more preferably by a printing process selected from the group consisting of rotogravure, screen printing and flexography, on a transparent substrate a coating composition comprising a binder material and the plurality of magnetic or magnetizable pigment particles to a transparent substrate, b) exposing the coating composition in a first state to the magnetic field of a magnetic-field-generating device, and c) hardening the coating composition to a second state so as to fix the magnetic or magnetizable pigment particles in their adopted positions and orientations so as to obtain a hardened coating and d) cutting the pre-structure obtained under step c) so as to obtain the first structure and the second structure.

In an embodiment, at least one of the first and second structures has a rolling bar effect portion and a coating (i.e. a hardened coating comprising oriented magnetic or magnetizable pigment particles) free portion and the first and second structures are laminated so that the coating free portion of one of the structures overlays a rolling bar effect portion of the other of the first and second structures.

In an embodiment, the process comprises providing a pre-structure exhibiting an effect of one or more rolling bars rolling in the first direction, cutting the pre-structure to provide the first and second structures and relatively flipping the first or second structure so that the first and second structures exhibit an effect of rolling bars rolling in the same direction prior to flipping and exhibit an effect of rolling bars rolling in opposite directions in the relatively flipped orientation.

In an embodiment, a plurality of spaced apart stripes of magnetic or magnetizable pigment particles oriented for exhibiting a rolling bar effect are provided on at least one of the first and second transparent substrates.

In an embodiment, the process comprises providing the first and second structures with a plurality of spaced apart stripes of magnetic or magnetizable pigment particles oriented for exhibiting a rolling bar effect and laminating them together with the stripes in a position so that the stripes of one of the structures coincides with the spaces between the stripes of the other of the structures.

The step exposing the coating composition in a first state to the magnetic field of a magnetic-field-generating device so as to orient the magnetic or magnetizable pigment particles (step b)) may be carried out subsequently or simultaneously with the step of applying the coating composition (step a)). Preferably, the applying step a) is carried out simultaneously with the step b) of exposing the coating to composition to the magnetic field of a magnetic-field-generating device so as to orient the magnetic or magnetizable pigment particles.

The coating composition described herein must thus noteworthy have a first state, i.e. a liquid or pasty state, wherein the coating composition is wet or soft enough, so that the magnetic or magnetizable pigment particles dispersed in the coating composition are freely movable, rotatable and/or orientable upon exposure to a magnetic field, and a second hardened (e.g. solid) state, wherein the pigment particles are fixed or frozen in their respective positions and orientations. Such a first and second state is preferably provided by using a certain type of coating composition. For example, the components of the coating composition other than the magnetic or magnetizable pigment particles may take the form of a coating composition such as those which are used in security applications, e.g. for banknote printing.

The aforementioned first and second state can be provided by using a binder material that shows a great increase in viscosity in reaction to a stimulus such as for example a temperature change or an exposure to an electromagnetic radiation. That is, when the fluid binder material is hardened or solidified, said binder material converts into the second state, i.e. a hardened or solid state, where the pigment particles are fixed in their current positions and orientations and can no longer move nor rotate within the binder material.

As known to those skilled in the art, ingredients comprised in a coating composition to be applied onto a substrate and the physical properties of said coating composition are determined by the nature of the process used to transfer coating composition to the surface. Consequently, the binder material comprised in the coating compositions described herein is typically chosen among those known in the art and depends on the coating or printing process used to apply the coating composition and the chosen hardening process.

Preferably, the coating composition is applied to a transparent substrate by a coating or a printing process and more preferably by a printing process selected from the group consisting of rotogravure, screen printing and flexography. These processes are well-known to the skilled man and are described for example in Printing Technology, J. M. Adams and P. A. Violin, Delmar Thomson Learning, 5^{th} Edition.

As known by those skilled in the art, the term rotogravure refers to a printing process which is described for example in “Handbook of print media”, Helmut Kipphan, Springer Edition, page 48. Rotogravure is a printing process wherein the image elements are engraved into the surface of a cylinder. The non-image areas are at a constant original level. Prior to printing, the entire printing plate (non-printing and printing elements) is inked with a composition and flooded with said composition. The composition is removed from the non-image by a wiper or a blade before printing, so that composition remains only in the cells. When the substrate to be printed travels between the cylinder and a rubber impression roller (hereafter referred as impression roller), it acts like a blotter and absorbs the remaining composition in the cells. The image is transferred from the cells to the substrate by a pressure typically in the range of 1 to 4 bars and by the adhesive forces between the substrate and the ink. The term rotogravure does not encompass intaglio printing processes (also referred in the art as engraved steel die or copper plate printing processes) which rely for example on a different type of ink.

Flexography preferably uses a unit with a doctor blade, preferably a chambered doctor blade, an anilox roller and plate cylinder. The anilox roller advantageously has small cells whose volume and/or density determines the composition application rate. The doctor blade lies against the anilox roller, and scraps off surplus composition at the same time. The anilox roller transfers the composition to the plate cylinder which finally transfers the composition to the substrate. Specific design might be achieved using a designed photopolymer plate. Plate cylinders can be made from polymeric or elastomeric materials. Polymers are mainly used as photopolymer in plates and sometimes as a seamless coating on a sleeve. Photopolymer plates are made from light-sensitive polymers that are hardened by ultraviolet (UV) light. Photopolymer plates are cut to the required size and placed in an UV light exposure unit. One side of the plate is completely exposed to UV light to harden or cure the base of the plate. The plate is then turned over, a negative of the job is mounted over the uncured side and the plate is further exposed to UV light. This hardens the plate in the image areas. The plate is then processed to remove the unhardened photopolymer from the nonimage areas, which lowers the plate surface in these nonimage areas. After processing, the plate is dried and given a post-exposure dose of UV light to cure the whole plate. Preparation of plate cylinders for flexography is described in Printing Technology, J. M. Adams and P. A. Dolin, Delmar Thomson Learning, 5^{th} Edition, pages 359-360.

Screen printing (also referred in the art as silkscreen printing) is a stencil process whereby a composition is transferred to a surface through a stencil supported by a fine fabric mesh of silk, synthetic fibers or metal threads stretched tightly on a frame. The pores of the mesh are blocked-up in the non-image areas and left open in the image area, the image carrier being called the screen. During printing, the frame is supplied with the composition which is flooded over the screen and a urging means such as for example a squeegee is then drawn across it, thus forcing the composition through the open pores of the screen. At the same time, the surface to be printed is held in contact with the screen and the ink is transferred to it. Preferably a rotary screen cylinder is used. Screen printing is further described for example in The Printing ink manual, R. H. Leach and R. J. Pierce, Springer Edition, 5^{th} Edition, pages 58-62 and in Printing Technology, J. M. Adams and P. A. Dolin, Delmar Thomson Learning, 5^{th} Edition, pages 293-328.

Following or simultaneously with the application on the transparent substrate of the coating composition comprising the binder and the plurality of magnetic or magnetizable pigments, the magnetic or magnetizable pigment particles are oriented by applying an external magnetic field with the use of a magnetic-field-generating device for orienting them according to a desired orientation pattern. Thereby, a permanent magnetic pigment particle is oriented such that its magnetic axis is aligned with the direction of the external magnetic field line at the pigment particle's location. A magnetizable pigment particle without an intrinsic permanent magnetic field is oriented by the external magnetic field such that the direction of its longest dimension is aligned with a magnetic field line at the pigment particle's location.

The magnetic or magnetizable pigment particles described herein are oriented by applying an external magnetic field with the use of a magnetic-field-generating device, said magnetic-field-generating device being preferably a magnetic orienting cylinder. Preferably, the magnetic orienting cylinder is thermo-regulated so as to avoid any deterioration of its structure and/or maintain good processing characteristics. The magnetic-field-generating device is positioned subsequently to the printing cylinder, i.e. the screen cylinder, the rotogravure cylinder or the flexography cylinder; alternatively, when the coating composition is applied on the transparent substrate by a rotogravure process, the magnetic-field-generating device may be included or incorporated in the impression roller. Suitable magnetic orienting cylinders consist of cylinders having a magnetized outer surface such as those described in WO 2011/107527 A1. Preferably, the magnetic orienting cylinder having a magnetized outer surface, wherein the magnetization is structured such as to represent a repetitive seamless pattern of suitable repetition length; in other words, the circumference of the cylinder is an exact multiple of the period (repetition length) of the repetitive pattern.

The magnetic orienting cylinder can be produced by wrapping a flexible permanent-magnetic plate (e.g. of “Plastoferrite”) around a cylindrical support body and fixing it in such position. The magnetized permanent-magnetic plate may be an engraved permanent magnetic plate, such as disclosed in WO 2005/002866 A1 and in WO 2008/046702 A1. In a preferred embodiment, the magnetic orienting cylinder is seamless coated with a “plastic magnet” coating, in which a seamless repetitive magnetization pattern is inscribed. Alternatively the outer cylinder surface of the seamless coated cylinder can be engraved with a seamless repetitive pattern, and magnetized as disclosed in WO 2005/002866 A1. The magnetic orienting cylinder described herein may additionally comprise permanent magnets or electromagnets disposed inside the cylindrical support body, in order to produce the effects disclosed in WO 2008/046702 A1.

Similar to the wrapping around a cylindrical support body with flexible magnetic plate, a magnetized sleeve could be useful as well on a cylindrical support body, which is seamless.

Suitable magnetic orienting cylinders for the present invention may be prepared by the process disclosed in WO 2011/107527 A1, i.e. a process comprising the steps of:

a) coating a cylindrical support body with a polymer material comprising a high-coercivity permanent-magnetic powder (such as for example hexaferrites of the formula MFe₁₂O₁₉ including strontium hexaferrite (SrO*6Fe₂O₃) or barium hexaferrite (BaO*6Fe₂O₃); “hard ferrites” of the formula MFe₂O₄ including cobalt ferrite (CoFe₂O₄) or magnetite (Fe₃O₄), wherein M is a bivalent metal ion, as well as their isostructural substitution derivatives; samarium-cobalt alloys; and rare-earth-iron-boron alloys (RE₂Fe₁₄B, e.g. “neodymium magnets” Nd₂Fe₁₄B), wherein RE is a trivalent rare earth ion or a mixture of trivalent rare earth ions) as a filler material and hardening the polymer material, so as to obtain a seamless coated cylinder, said coating and hardening may be performed either by applying a hot, molten thermoplastic composition and cooling down to solidify the composition, or by applying a Plastisol precursor composition and heat-curing so as to form and solidify the Plastisol;
b) optionally rectifying the outer surface of the coated cylinder to obtain a standard cylinder diameter; and
c) magnetizing the outer cylinder surface of step a) or step b).

The coating and hardening step can be performed either by applying a hot, molten thermoplastic composition and cooling down to solidify the composition, or by applying a Plastisol precursor composition and heat-curing so as to form and solidify the Plastisol.

The polymer material recited in the coating step a) can be chosen from the thermoplastic materials which are commonly used to make “plastic magnets”, such as polyethylene or a polyamide. Low Density Poly-Ethylene (LDPE) is hot-meltable and can be used to formulate plastic magnet compositions (H. S. Gokturk et al. A TEC '92; Annual Technical Conference of the Society of Plastics Engineers, Detroit, Mich., May 1992; pages 491-494; Journal of Applied Polymer Science, Vol 50, 1891-1901, (1993)). Plastic and rubber magnets were first disclosed in FR 1135734 A (M. J. Dedek; 1955). JP 56000851 A2 (Komeno Hiroshi; 1981) discloses a plastic magnet composition on the basis of thermoplastic polyamide resin. See also H. Stablein, “Hard Ferrites and Plastoferrites”, in Ferromagnetic Materials, Vol, 3, ed. E. P. Wohlfarth, North-Holland Publishing company, 1982, chapter 7, pages 441-602.

The coating of the cylindrical support body recited in the coating step a) may then be performed, e.g. in analogy to T. Sakai et al., Intern, Polymer Processing, 6, 26-34 (1991) disclosing a plastics magnet manufacturing process, relying on Nylon 6 as thermoplastic binder and strontium hexaferrite (SrO*6Fe₂O₃) powder of 1.1-1.2 micrometer particle size as a high-coercivity permanent-magnetic filler material. Alternatively, the coating of the cylindrical support body may be performed according to U.S. Pat. No. 3,785,286, U.S. Pat. No. 3,900,595, and U.S. Pat. No. 4,054,685, those documents disclosing a Plastisol coating process, using polyvinyl chloride (PVC) in conjunction with one or more plasticisers and a stabilizer. The Plastisol composition, including the permanent-magnetic filler material, is formulated and applied onto the cylindrical support body at temperatures of about 40° C. to about 50° C., and hardened at temperatures of about 200° C. to about 250° C. The Plastisol coating is applied in several layers, each having a thickness between 0.3 and 1 mm, up to a total thickness of 2 to 3.5 mm.

Preferably, the high-coercivity permanent-magnetic powders recited in the rectifying step b) are used in the composition in a demagnetized state, such as to prevent a magnetic agglomeration of the magnetic powder particles. The demagnetization (“degaussing”) of magnetic materials is an operation known to the skilled person. Preferably, a magnetization is only applied after the composition is in place and hardened.

The optional rectification step b) is a mechanical ablation operation on a lath. It serves to establish precise mechanical dimension, in order to provide that the circumference of the cylinder is an exact multiple of the period (repetition length) of the repetitive magnetization pattern.

The magnetization of the cylinder surface recited in the magnetizing step c) may be performed as known to the skilled person, e.g. by applying a magnetic stylus according to U.S. Pat. No. 3,011,436 or in electromagnetic and mechanical analogy to U.S. Pat. No. 3,011,436 disclosure, by inscribing the required repetitive magnetization pattern with a mechanically driven electromagnetic stylus. In a particularly preferred embodiment of the process, magnetizing step c) comprises a step of engraving the outer surface of the coated cylinder with a repetitive seamless pattern, and magnetizing the cylinder. The engraving and magnetization of the outer cylinder surface can be performed as disclosed in WO 2005/002666 A1. In particular, the engraving can be performed using ablative tools selected from the group comprising mechanical ablation tools, gaseous or liquid jet ablation tools, and laser ablation tools. The magnetization can be applied before or after the engraving step. The magnetization of the outer surface of the cylinder may furthermore be combined with the disposition of magnets inside the cylindrical support body, as disclosed in WO 2008/046702 A1; said magnets may further be permanent magnets or electromagnets.

As described hereabove, for achieving a coating comprising magnetic or magnetizable pigments particles oriented to follow a convex curvature (negative curved orientation) when viewed from the side carrying the coating, the magnetic-field-generating device for orienting said pigment particles is applied from the bottom of the substrate on the opposite side of the substrate to the side carrying the coating, i.e. from the side facing the transparent substrate (see FIGS. 3A-B).

Subsequently or simultaneously with the step of exposing the coating composition in a first state to the magnetic field of a magnetic-field-generating device so as to orient the magnetic or magnetizable pigment particles (step b)), the coating composition is hardened (hardening step c)) so that the orientation of the pigment particles is fixed. Preferably, the hardening step c) is carried out simultaneously with step b).

The hardening step c) can be of purely physical nature. Alternatively and preferably, the hardening of the coating composition involves a chemical reaction, for instance hardening is induced by curing, which is not reversed by a simple temperature increase (e.g. up to 80° C.) that may occur during a typical use of a security document. The term “curing” or “curable” refers to processes including the chemical reaction, crosslinking or polymerization of at least one component in the applied coating composition in such a manner that it turns into a polymeric material having a greater molecular weight than the starting substances. Preferably, the curing causes the formation of a three-dimensional polymeric network.

Such a curing is generally induced by applying an external stimulus to the coating composition (i) after its application on a substrate and (ii) subsequently or simultaneously with the orientation of the magnetic or magnetizable pigment particles. Therefore, preferably suitable coating compositions for producing the first hardened coating and the second hardened coating are coating compositions selected from the group consisting of radiation curable compositions, thermal drying compositions and combinations thereof and the hardening step c) is preferably carried out by using hot air, radiation (including infra-red radiation, UV-visible light radiation and E-beam radiation) or by any combination thereof.

According to one aspect of the present invention, the coating compositions described herein consist of thermal drying compositions. Thermal drying compositions consist of compositions of any type of aqueous compositions or solvent-based compositions which are dried by hot air, infrared or by a combination of hot air and infrared. Typical examples of thermal drying compositions comprises components including without limitation resins such as polyester resins, polyether resins, vinyl chloride polymers and vinyl chloride based copolymers, nitrocellulose resins, cellulose acetobutyrate or acetopropionate resins, maleic resins, polyamides, polyolefins, polyurethane resins, functionalized polyurethane resins (e.g. carboxylated polyurethane resins), polyurethane alkyd resins, polyurethane-(meth)acrylate resins, urethane-(meth)acrylic resins, styrene(meth)acrylate resins or mixtures thereof. The term “(meth)acrylate” or “(meth)acrylic” in the context of the present invention refers to the acrylate as well as the corresponding methacrylate or refers to the acrylic as well as the corresponding methacrylic.

As used herein, the term “solvent-based compositions” refers to compositions whose liquid medium or carrier substantially consists of one or more organic solvents. Examples of such solvents include without limitation alcohols (such as for example methanol, ethanol, isopropanol, n-propanol, ethoxy propanol, n-butanol, sec-butanol, tert-butanol, iso-butanol, 2-ethylhexyl-alcohol and mixtures thereof); polyols (such as for example glycerol, 1,5-pentanediol, 1,2,6-hexanetriol and mixtures thereof); esters (such as for example ethyl acetate, n-propyl acetate, n-butyl acetate and mixtures thereof); carbonates (such as for example dimethyl carbonate, diethylcarbonate, di-n-butylcarbonate, 1,2-ethylencarbonate, 1,2-propylenecarbonate, 1,3-propylencarbonate and mixtures thereof); aromatic solvents (such as for example toluene, xylene and mixtures thereof); ketones and ketone alcohols (such as for example acetone, methyl ethyl ketone, methyl isobutyl ketone, cyclohexanone, diacetone alcohol and mixtures thereof); amides (such as for example dimethylformamide, dimethyl-acetamide and mixtures thereof); aliphatic or cycloaliphatic hydrocarbons; chlorinated hydrocarbons (such as for example dichloromethane); nitrogen-containing heterocyclic compound (such as for example N-methyl-2-pyrrolidone, 1,3-dimethyl-2-imidazolidone and mixtures thereof); ethers (such as for example diethyl ether, tetrahydrofuran, dioxane and mixtures thereof); alkyl ethers of a polyhydric alcohol (such as for example 2-methoxyethanol, 1-methoxypropan-2-ol and mixtures thereof); alkylene glycols, alkylene thioglycols, polyalkylene glycols or polyalkylene thioglycols (such for example ethylene glycol, polyethylene glycol (such as for example diethylene glycol, triethylene glycol, tetraethylene glycol), propylene glycol, polypropylene glycol (such as for example dipropylene glycol, tripropylene glycol), butylene glycol, thiodiglycol, hexylene glycol and mixtures thereof); nitriles (such as for example acetonitrile, propionitrile and mixtures thereof), and sulfur-containing compounds (such as for example dimethylsulfoxide, sulfolan and mixtures thereof). Preferably, the one or more organic solvents are selected from the group consisting of alcohols, esters and mixtures thereof.

According to one aspect of the present invention, the coating compositions described herein consist of radiation curable compositions. Radiation curable compositions include compositions that may be cured by IR-radiation, UV-visible light radiation (hereafter referred as UV-Vis-curable) or by E-beam radiation (hereafter referred as EB). Radiation curable compositions are known in the art and can be found in standard textbooks such as the series “Chemistry & Technology of UV & EB Formulation for Coatings, Inks & Paints”, published in 7 volumes in 1997-1998 by John Wiley & Sons in association with SITA Technology Limited. Preferably, the coating compositions described herein consist of UV-Vis-curable compositions.

Preferably the binder of the UV-Vis-curable compositions described herein is prepared from oligomers (also referred in the art as prepolymers) selected from the group consisting of radically curable compounds, cationically curable compounds and mixtures thereof. Cationically curable compounds are cured by cationic mechanisms consisting of the activation by energy of one or more photoinitiators which liberate cationic species, such as acids, which in turn initiate the polymerization so as to form the binder. Radically curable compounds are cured by free radical mechanisms consisting of the activation by energy of one or more photoinitiators which liberate free radicals which in turn initiate the polymerization so as to form the binder.

UV-Vis curing of a monomer, oligomer or prepolymer may require the presence of one or more photoinitiators and may be performed in a number of ways. As known by those skilled in the art, the one or more photoinitiators are selected according to their absorption spectra and are selected to fit with the emission spectra of the radiation source. Depending on the monomers, oligomers or prepolymers used to prepare the binder comprised in the UV-Vis-curable compositions described herein, different photoinitiators might be used. Suitable examples of free radical photoinitiators are known to those skilled in the art and include without limitation acetophenones, benzophenones, alpha-aminoketones, alpha-hydroxyketones, phosphine oxides and phosphine oxide derivatives and benzyldimethyl ketals. Suitable examples of cationic photoinitiators are known to those skilled in the art and include without limitation onium salts such as organic iodonium salts (e.g. diaryl iodoinium salts), oxonium (e.g. triaryloxonium salts) and sulfonium salts (e.g. triarylsulphonium salts). Other examples of useful photoinitiators can be found in standard textbooks such as “Chemistry & Technology of UV & EB Formulation for Coatings, Inks & Paints”, Volume III, “Photoinitiators for Free Radical Cationic and Anionic Polymerization”, 2nd edition, by J. V. Crivello & K. Dietliker, edited by G. Bradley and published in 1998 by John Wiley & Sons in association with SITA Technology Limited. It may also be advantageous to include a sensitizer in conjunction with the one or more photoinitiators in order to achieve efficient curing. Typical examples of suitable photosensitizers include without limitation isopropyl-thioxanthone (ITX), 1-chloro-2-propoxy-thioxanthone (CPTX), 2-chloro-thioxanthone (CTX) and 2,4-diethyl-thioxanthone (DETX) and mixtures thereof. The one or more photoinitiators comprised in the UV-Vis-curable compositions are preferably present in an amount from about 0.1 wt-% to about 20 wt-%, more preferably about 1 wt-% to about 15 wt-%, the weight percents being based on the total weight of the UV-Vis-curable compositions.

Alternatively, dual-cure coating compositions may be used; these compositions combine thermal drying and radiation curing mechanisms. Typically, such compositions are similar to radiation curing compositions but include a volatile part constituted by water and/or by solvent. These volatile constituents are evaporated first using hot air and/or IR driers, and UV-Vis drying is then completing the hardening process.

The first plurality of magnetic or magnetizable pigment particles and the second plurality of magnetic or magnetizable pigment particles described herein are dispersed in a first hardened coating and in a second hardened coating, said first and second hardened coatings comprising a hardened binder material that fixes the position and orientation of the magnetic or magnetizable pigment particles. The magnetic or magnetizable pigment particles of the first hardened coating may be the same or may be different from the magnetic or magnetizable pigment particles of the second hardened coating. The hardened binder material is at least partially transparent to electromagnetic radiation of one or more wavelengths in the range of 200 nm to 2500 nm. Preferably, the hardened binder material is at least partially transparent to electromagnetic radiation of one or more wavelengths in the range of 200-800 nm, more preferably in the range of 400-700 nm. Herein, the term “one or more wavelengths” denotes that the binder material may be transparent to only one wavelength in a given wavelength range, or may be transparent to several wavelengths in a given range. Preferably, the binder material is transparent to more than one wavelength in the given range, and more preferably to all wavelengths in the given range. Thus, in a more preferred embodiment, the hardened binder material is at least partly transparent to all wavelengths in the range of about 200-about 2500 nm (or 200-800 nm, or 400-700 nm), and even more preferably the hardened binder material is fully transparent to all wavelengths in these ranges. Herein, the term “transparent” denotes that the transmission of electromagnetic radiation through a layer of 20 μm of the hardened binder material as present in the security thread or stripe (not including the magnetic or magnetizable pigment particles, but all other optional components of the coating composition in case such components are present) is at least 80%, more preferably at least 90%, even more preferably at least 95%. This can be determined for example by measuring the transmittance of a test piece of the hardened binder material (not including the magnetic or magnetizable pigment particles) in accordance with well-established test methods, e.g. DIN 5036-3 (1979-11).

Preferably, the magnetic or magnetizable pigment particles described herein are present in an amount from about 5 wt-% to about 40 wt-%, more preferably about 10 wt-% to about 30 wt-%, the weight percentages being based on the total weight of the coating composition.

Preferably, the magnetic or magnetizable pigment particles of the first plurality and/or of the second plurality described herein are non-spherical pigment particles and, more preferably, they are prolate or oblate ellipsoid-shaped, platelet-shaped or needle-shaped particles or mixtures thereof.

Suitable examples of magnetic or magnetizable pigment particles described herein include without limitation pigment particles comprising a ferromagnetic or a ferrimagnetic metal such as cobalt, iron, or nickel; a ferromagnetic or ferrimagnetic alloy of iron, manganese, cobalt, iron or nickel; a ferromagnetic or ferrimagnetic oxide of chromium, manganese, cobalt, iron, nickel or mixtures thereof; as well as the mixtures thereof. Ferromagnetic or ferrimagnetic oxides of chromium, manganese, cobalt, iron, nickel or mixtures thereof may be pure or mixed oxides. Examples of magnetic oxides include without limitation iron oxides such as hematite (Fe₂O₃), magnetite (Fe₃O₄), chromium dioxide (CrO₂), magnetic ferrites (MFe₂O₄), magnetic spinets (MR₂O₄), magnetic hexaferrites (MFe₁₂O₁₉), magnetic orthoferrites (RFeO₃), magnetic garnets M₃R₂(AO₄)₃, wherein M stands for a two valent and R for a three-valent, and A for a four-valent metal ion, and “magnetic” for ferro- or ferrimagnetic properties.

Preferably, at least a part of the first plurality of magnetic or magnetizable pigment particles and/or at least a part of the second plurality of magnetic or magnetizable pigment particles described herein is constituted by optically variable magnetic or magnetizable pigment particles. Such optically variable magnetic or magnetizable pigment particles are preferably non-spherical and more preferably are prolate or oblate ellipsoid-shaped, platelet-shaped or needle-shaped pigments particles, or mixtures thereof. Optically variable elements are known in the field of security printing. Optically variable elements (also referred in the art as colorshifting or goniochromatic elements) exhibit a viewing-angle or incidence-angle dependent color, and are used to protect banknotes and other security documents against counterfeiting and/or illegal reproduction by commonly available color scanning, printing and copying office equipment. For example, coatings or layers comprising optically variable magnetic or magnetizable pigment particles exhibits a colorshift upon variation of the viewing angle (e.g. from a viewing angle of about 90° with respect to the plane of the coating or layer to a viewing angle of about 22.5° with respect to the plane of the coating or layer) from a color impression CI1 (e.g. green) to a color impression CI2 (blue). In addition to the overt security provided by the colorshifting property of the optically variable magnetic or magnetizable pigment particles, which allows an easy detection, recognition and/or discrimination of the security threads or stripes described herein from their possible counterfeits with the unaided human senses, the colorshifting property of the optically variable magnetic or magnetizable pigment particles may be used as a machine readable tool for the recognition of the security threads or stripes. Thus, the colorshifting properties of the optically variable magnetic or magnetizable pigment particles may simultaneously be used as a covert or semi-covert security feature in an authentication process wherein the optical (e.g. spectral) properties of the particles are analyzed. The use of optically variable magnetic or magnetizable pigment particles enhances the significance of the security threads or stripes described herein, because such materials (i.e. optically variable magnetic or magnetizable pigment particles) are reserved to the security document printing industry and are not commercially available to the public.

The optically variable magnetic or magnetizable pigment particles described herein suitable for the first hardened coating and/or the second hardened coating are preferably selected from the group consisting of magnetic thin-film interference pigments, magnetic cholesteric liquid crystal pigments, interference coated pigments comprising one or more magnetic materials and mixtures thereof. The optically variable magnetic or magnetizable pigment particles of the first hardened coating may be the same or may be different from the magnetic or magnetizable pigment particles of the second hardened coating, by being the same or different, it is meant that either the chemical structure of said pigment particles is the same or different, or the colorshifting properties of said pigment particles is the same or different, or both are the same or different.

Magnetic thin film interference pigments are known to those skilled in the art and are disclosed e.g. in U.S. Pat. No. 4,838,648; WO 2002/073250 A2; EP 686 675 A1; WO 2003/000801 A2; U.S. Pat. No. 6,838,166; WO 2007/131833 A1 and in the thereto related documents. Due to their magnetic characteristics, they are machine readable, and therefore coating compositions comprising magnetic thin film interference pigments may be detected for example with specific magnetic detectors. Therefore, coating compositions comprising magnetic thin film interference pigments may be used as a covert or semi-covert security element (authentication tool) for security documents. Preferably, the magnetic thin film interference pigments comprise pigments having a five-layer Fabry-Perot multilayer structure and/or pigments having a six-layer Fabry-Perot multilayer structure and/or pigments having a seven-layer Fabry-Perot multilayer structure. Preferred five-layer Fabry-Perot multilayer structures consist of absorber/dielectric/reflector/dielectric/absorber multilayer structures wherein the reflector and/or the absorber is also a magnetic layer. Preferred six-layer Fabry-Perot multilayer structures consist of absorber/dielectric/reflector/magnetic/dielectric/absorber multilayer structures. Preferred seven-layer Fabry Perot multilayer structures consist of absorber/dielectrio/reflector/magnetic/reflector/dielectric/absorber multilayer structures such as disclosed in U.S. Pat. No. 4,838,648; and more preferably seven-layer Fabry-Perot absorber/dielectric/reflector/magnetic/reflector/dielectric/absorber multilayer structures. Preferably, the reflector layers described herein are selected from the group consisting of metals, metal alloys and combinations thereof, preferably selected from the group consisting of reflective metals, reflective metal alloys and combinations thereof, and more preferably from the group consisting of aluminum (Al), chromium (Cr), nickel (Ni), and mixtures thereof and still more preferably aluminum (Al). Preferably, the dielectric layers are independently selected from the group consisting of magnesium fluoride (MgF₂), silicium dioxide (SiO₂) and mixtures thereof, and more preferably magnesium fluoride (MgF₂). Preferably, the absorber layers are independently selected from the group consisting of chromium (Cr), nickel (Ni), metallic alloys and mixtures thereof. Preferably, the magnetic layer is preferably selected from the group consisting of nickel (Ni), iron (Fe) and cobalt (Co), alloys comprising nickel (Ni), iron (Fe) and/or cobalt (Co), and mixtures thereof. It is particularly preferred that the magnetic thin film interference pigments comprise a seven-layer Fabry-Perot absorber/dielectric/reflector/magnetic/reflector/dielectric/absorber multilayer structure consisting of a Cr/MgF₂/Al/Ni/Al/MgF₂/Cr multilayer structure. Magnetic thin film interference pigments described herein are typically manufactured by vacuum deposition of the different required layers onto a web. After deposition of the desired number of layers, e.g. by PVD, the stack of layers is removed from the web, either by dissolving a release layer in a suitable solvent, or by stripping the material from the web. The so-obtained material is then broken down to flakes which have to be further processed by grinding, milling or any suitable method. The resulting product consists of flat flakes with broken edges, irregular shapes and different aspect ratios. Further information on the preparation of suitable magnetic thin film interference pigments can be found e.g. in EP 1 710 756 A1, which is hereby incorporated by reference.

Suitable magnetic cholesteric liquid crystal pigments exhibiting optically variable characteristics include without limitation monolayered cholesteric liquid crystal pigments and multilayered cholesteric liquid crystal pigments Such pigments are disclosed for example in WO 2006/063926 A1, U.S. Pat. No. 6,582,781 and U.S. Pat. No. 6,531,221. WO 2006/063926 A1 discloses monolayers and pigments obtained therefrom with high brilliance and colorshifting properties with additional particular properties such as magnetizability. The disclosed monolayers and pigments, which are obtained therefrom by comminuting said monolayers, comprise a three-dimensionally crosslinked cholesteric liquid crystal mixture and magnetic nanoparticles. U.S. Pat. No. 6,582,781 and U.S. Pat. No. 6,410,130 disclose platelet-shaped cholesteric multilayer pigments which comprise the sequence A¹/B/A², wherein A¹ and A² may be identical or different and each comprises at least one cholesteric layer, and B is an interlayer absorbing all or some of the light transmitted by the layers A¹ and A² and imparting magnetic properties to said interlayer. U.S. Pat. No. 6,531,221 discloses platelet-shaped cholesteric multilayer pigments which comprise the sequence NB and if desired C, wherein A and C are absorbing layers comprising pigments imparting magnetic properties, and B is a cholesteric layer.

Suitable interference coated pigments comprising one or more magnetic materials include without limitation structures consisting of a substrate selected from the group consisting of a core coated with one or more layers, wherein at least one of the core or the one or more layers have magnetic properties. For example, suitable interference coated pigments comprise a core made of a magnetic material such as those described hereabove, said core being coated with one or more layers made of metal oxides as well as structure consisting of a core made of synthetic or natural micas, layered silicates (e.g. talc, kaolin and sericite), glasses (e.g. borosilicates), silicium dioxides (SiO₂), aluminum oxides (Al₂O₃), titanium oxides (TiO₂), graphites and mixtures thereof.

In addition to the magnetic or magnetizable pigment particles (which may or may not comprise or consist of optically variable magnetic or magnetizable pigment particles), also non-magnetic or non-magnetizable particles may be contained in the coating compositions described herein. These particles may be dyes or color pigments known in the art, having or not having optically variable properties. Further, these particles may be spherical or non-spherical and may have isotropic or non-isotropic optical reflectivity.

The coating compositions described herein may further comprise one or more machine readable materials. When present, the one or more machine readable materials are preferably selected from the group consisting of magnetic materials, luminescent materials, electrically conductive materials, infrared-absorbing materials and mixtures thereof. As used herein, the term “machine readable material” refers to a material which exhibits at least one distinctive property which is detectable by a device or a machine, and which can be comprised in a coating so as to confer a way to authenticate said coating or article comprising said coating by the use of a particular equipment for its detection and/or authentication.

The coating compositions described herein may further comprise one or more additives including without limitation compounds and materials which are used for adjusting physical, rheological and chemical parameters of the composition such as the viscosity (e.g. solvents and surfactants), the consistency (e.g. anti-settling agents, fillers and plasticizers), the foaming properties (e.g. antifoaming agents), the lubricating properties (waxes), UV stability (photosensitizers and photostabilizers) and adhesion properties, etc. Additives described herein may be present in the coating compositions described herein in amounts and in forms known in the art, including in the form of so-called nano-materials where at least one of the dimensions of the particles is in the range of 1 to 1000 nm.

The coating compositions described herein may be prepared by dispersing or mixing the magnetic or magnetizable pigment particles described herein and the one or more additives when present in the presence of the binder material described herein, thus forming liquid compositions. When present, the one or more photoinitiators may be added to the composition either during the dispersing or mixing step of all other ingredients or may be added at a later stage, i.e. after the formation of the liquid coating composition.

As mentioned hereabove, the process according to the present comprises a step of laminating a first structure comprising a transparent substrate and a first plurality of oriented magnetic or magnetizable pigment particles dispersed in the first hardened coating described herein with a second structure comprising a transparent substrate and a second plurality of oriented magnetic or magnetizable pigment particles dispersed in the second hardened coating dispersed herein. The transparent substrate of the first structure and the transparent substrate of the second structure may be the same or may be different. The security thread or stripe produced according to the process of the present invention comprises two transparent substrates, one originating from the first structure and the other originating from the second structure. Preferably, the transparent substrate of the first structure and the transparent substrate of the second structure are independently made of one or more plastics or polymers. Typical examples of polymer or plastic substrates include polyolefins such as polyethylene and polypropylene (monoaxial or biaxial oriented polypropylenes), polyamides, polyesters such as poly(ethylene terephthalate) (PET), poly(1,4-butylene terephthalate) (PBT), poly(ethylene 2,6-naphthoate) (PEN) and polyvinylchlorides (PVC).

The transparent substrate of the first structure and/or the transparent substrate of the second structure may be colored or may be metalized substrates, said metalized substrates comprising indicia so that the first hardened coating and the second hardened coating of the security thread or stripe are at least partially jointly visible from one side of said security thread or stripe described herein. Typical examples of metalized materials include without limitation plastic or polymer materials (such as those described hereabove) having a metal disposed discontinuously on their surface. Typical example of metals include without limitation aluminum (Al), chromium (Cr), copper (Cu), gold (Au), iron (Fe), nickel (Ni), silver (Ag), combinations thereof or alloys of two or more of the aforementioned metals. The metallization of the material described hereabove may be done by an electrodeposition process, a high-vacuum coating process or by a sputtering process. Typically, the metal has a thickness between about 1 and about 100 nanometers (nm). The indicia of the metalized substrate described herein may consist of positive text or clear text. By “positive text”, it is meant that the indicia consist of a metal surrounded by a demetalized area and by “clear text”, it is meant that the indicia consist of negative text, i.e. a metal material comprising is demetalized parts in the form of indicia in negative writing. The demetalized parts may be produced by processes known to those skilled in the art such as for example chemical etching, laser etching or washing methods.

With the aim of facilitating an automatic authenticity check of the security thread or stripe described herein or a security document comprising said security thread or stripe by an authentication apparatus such as for example an automatic teller machine (ATMs), the process described herein may further comprise a step of applying on the transparent substrate of the first structure and/or the transparent substrate of the second structure one or more machine readable layers before the laminating step. Said one or more machine readable layers may be continuous or discontinuous and are preferably applied between the transparent substrate and the first hardened coating and/or the second hardened coating provided that the first hardened coating and the second hardened coating of the laminated security thread or stripe are at least partially jointly visible from one side of said security thread or stripe described herein. When present, the one or more machine readable layers preferably comprise a machine readable material selected from the group consisting of magnetic materials, luminescent materials, electrically conductive materials, infrared-absorbing materials and mixtures thereof.

With the aim of further increasing the resistance against counterfeiting or illegal reproduction of the security thread or stripe described herein, it might be advantageous to apply one or more hiding layers so as to camouflage any information that is present in the security thread or stripe such as for example any information related to the one or more machine readable layers described hereabove. For example, magnetic or other machine readable information which is visually discernible could be more easily counterfeited if the potential counterfeiter can detect the presence and/or the placement of the magnetic regions to read. If the magnetic or other machine readable information cannot be visually seen, the counterfeiter will not be motivated to reproduce this information and therefore the counterfeiting will fail and be easily detected if illegally reproduced. Typical examples of hiding layers include without limitation aluminum layers, black layers, white layers, opaque colored layers and metalized layers and combination of thereof. As mentioned hereabove for the one or more machine readable layers, the one or more hiding layers may be may be continuous or discontinuous and are preferably apply on the one or more machine readable layers provided that the first hardened coating and the second hardened coating of the laminated security thread or stripe are at least partially jointly visible from one side of said security thread or stripe described herein.

The first hardened coating and the second hardened coating of the laminated structure described herein may be adjacent to or spaced apart each other. By “adjacent”, it is meant that the first hardened coating and the second hardened coating are in direct contact. By “spaced apart”, it is meant that the first hardened coating and the second hardened coating are not in direct contact and that a distance less 50% of the width of the security thread or stripe, preferably between about 5% and 35% of the width of the security thread or stripe, is present between said first and second hardened coatings.

As shown and exemplified in FIGS. 4A to 4D, the first hardened coating (1) and/or the second hardened coating (2) of the laminated structure described herein may be continuously present along the length of the security thread as described herein (FIGS. 4A and 4B). Alternatively the first hardened coating (1) and/or the second hardened coating (2) of the laminated structure described herein may be continuously present along the width of the security thread as described herein (FIG. 4C). Alternatively, the first hardened coating (1) and/or the second hardened coating (2) of the laminated structure described herein may be discontinuously present or may be in the form of indicia such as for examples rectangles or letters (FIG. 4D).

The process for producing a security thread or stripe according to the present invention may further comprise a step of applying one or more adhesive layers, preferably one or more thermoadhesive layers, on the transparent substrate of the first structure and/or on the transparent substrate of the second structure of the security thread or stripe described herein, said step being preferably carried out after the laminating step. Applying one or more adhesive layers, preferably one or more thermoadhesive layers, on the surface of the security thread or stripe described herein provides adherence to a security document upon incorporation of the thread or stripe into or onto said security document.

The process for producing a security thread or stripe according to the present invention may further comprise a step of slicing the laminated structure obtained after the laminating step to produce a plurality of security threads or stripes exhibiting the effect of rolling bars rolling in opposite directions. Preferably the laminated structure is sliced so as to obtain a plurality of security threads or stripes having a width, i.e. dimension in the transverse direction, between about 0.5 mm and about 30 mm, more preferably between about 0.5 mm and about 5 mm. When a step of applying one or more adhesive layers on the transparent substrate of the first structure and/or on the transparent substrate of the second structure as described herein is performed, the step of slicing the laminated structure is carried out subsequently to the applying one or more adhesive layers step.

Also described herein are security threads or stripes produced by the process described herein.

Also described herein are security threads and security documents comprising said security threads. The security threads comprise a laminated structure comprising a first structure and a second structure. The first and second structures each comprise a transparent substrate and a plurality of magnetic or magnetizable pigment particles. The pigment particles are dispersed in a hardened coating and oriented for exhibiting a rolling bar effect. The transparent substrates face outwardly in the laminated structure and the hardened coatings of the first and second structures are comprised between the transparent substrates in the laminated structure. The first or the second structure has a portion free of coating through which the underlying oriented magnetic or magnetizable pigment particles of the other of the first or the second structures can be viewed from one side of the security thread or stripe. As such, rolling bar effects provided by the oriented pigment particles of the first structure and the second structure are jointly visible from the one side of the security thread or stripe. The joint effect is that of rolling bars respectively provided by the first and second structures rolling in opposite directions when the security thread or stripe is tilted. Magnetic or magnetizable pigment particles of the first structure have an orientation following a convex curvature when viewed from the one side of the security thread or stripe and the magnetic or magnetizable pigment particles of the second structure have an orientation following a concave curvature when viewed from the one side of the security thread or stripe so as to form the rolling bars rolling in opposite directions.

The security documents provided by the present invention comprise such a security thread or stripe. The security thread or stripe is at least partially embedded in the security documents or the security thread or stripe is mounted on the surface of the security documents.

The security threads or stripes are particularly suitable for the protection of a security document against counterfeiting or fraud. Therefore, the present invention provides a process for producing a security document comprising the security thread or stripe described herein and security documents obtained therefrom.

Security documents are usually protected by several security features which are chosen from different technology fields, manufactured by different suppliers, and embodied in different constituting parts of the security document. To break the protection of the security document, the counterfeiter would need to obtain all of the implied materials and to get access to all of the required processing technology, which is a hardly achievable task. Examples of security documents include without limitation value documents and value commercial goods. Typical example of value documents include without limitation banknotes, deeds, tickets, checks, vouchers, fiscal stamps and tax labels, agreements and the like, identity documents such as passports, identity cards, visas, bank cards, credit cards, transactions cards, access documents, entrance tickets and the like. The term “value commercial good” refers to packaging material, in particular for pharmaceutical, cosmetics, electronics or food industry that may comprise one or more security features in order to warrant the content of the packaging like for instance genuine drugs. Example of these packaging material include without limitation labels such as authentication brand labels, tamper evidence labels and seals. Preferably, the security document described herein is selected from the group consisting of banknotes, identity documents such as passports, identity cards, driving licenses and the like and more preferably banknotes.

The security thread or stripe produced by the process can be incorporated into or onto any security document, in particular papers and polymers used to make security documents so as to confer resistance against counterfeiting or illegal reproduction of the security thread or stripe. The present invention provides a process for producing a security document comprising a security thread or stripe.

The process for producing a security document described herein comprises a step of at least partially embedding therein the security thread or stripe produced by the process described herein or a step of mounting the security thread or stripe produced by the process described herein on the surface of the security document.

The security thread or stripe described herein may be at least partially embedded into the security document as a windowed security thread or stripe so that said security thread or stripe is at least partially visible from one side of the security document. When the security document comprises a substrate being a security paper, the security thread or stripe described herein may be at least partially incorporated in the security paper during manufacture by techniques commonly employed in the paper-making industry. For example, the security thread or stripe described herein may be pressed within wet paper fibers while the fibers are unconsolidated and pliable, thus resulting in the security thread or stripe being totally embedded in the resulting security paper. The security thread or stripe described herein may also be fed into a cylinder mold papermaking machine, cylinder vat machine, or similar machine of known type, resulting in partial embedment of the security thread or stripe within the body of the finished paper (i.e. windowed paper).

Alternatively, the security thread or stripe described herein may be disposed completely on the surface of the security document as a transfer element. In such as case, the security thread or stripe described herein may be mounted on the surface of the security document by any known techniques including without limitation applying a pressure-sensitive adhesive to a surface of the security thread or stripe, applying a heat activated adhesive to a surface of the security thread or stripe or using thermal transfer techniques.

### Examples

The present nvention is now described in greater detail with respect to non-limiting examples.

TABLE 1

| | coating |
|---|---|
| Ingredients | composition |
| optically variable magnetic pigment particles | 30 |
| with a colorshift gold to green (OVMP ®, thin | |
| film interference pigments, from JDS | |
| UNIPHASE CORPORATION, Milpitas CA USA) | |
| nitrocellulose | 20 |
| polyether polyurethane resin | 10 |
| ethyl acetate | 24 |
| n-propyl acetate | 14.5 |
| hydrophilic fumed silica | 0.5 |
| micronized PTFE-modified polyethylene wax | 1.0 |

The wt-% are based on the total weight of the coating composition.

100 g of the coating composition was prepared by mixing the ingredients described in Table 1. Mixing at room temperature was done with a dispersing propeller (stainless steel 4.0 cm diameter) at a speed of 2000 rpm for a period of ten minutes.

The coating composition was applied to a transparent substrate (PET, 12 microns, cut in pieces of 1 meter long) so as to form a pre-structure by rotogravure at a speed of 30 m/min (TESTACOLOR FTM-145 sold by Norbert Schläfli Engler Maschinen) in the form of patterns, having the shape of continuous stripes in the printing direction, 4 mm in width with 4 mm non-printed gaps in between. The coating composition was applied and simultaneously magnetized when the PET passed through the gravure cylinder and the impression roller. The coating composition was hardened with the use of an IR heated tunnel of 1 meter long at a temperature of 100° C. and the position and orientation of the optically variable magnetic or magnetizable pigment particles was fixed.

The orientation of the optically variable magnetic or magnetizable pigment particles was achieved by using a magnetic-field generating device. A thin piece of Plastoferrite foil was used to wrap the impression roller of the TESTACOLOR FTM-145. The Plastoferrite foil was 1 mm thick and had a multipolar magnetic field. A rectangular piece (16 cm×18 cm) was cut out from the Plastoferrite foil in such a way that it wrapped tightly and smoothly around on the surface of the impression roller and created no seam in the repetitive magnetic image where the two ends of the foil met. Finally, the foil was firmly fixed on the impression roller by scotch tapes in such a way that there was no impact on the smooth and cylindrical surface.

A homogenous layer of a lamination glue was applied by a Mayer bar (a hand coater bar Nr. 3) on the printed side of the PET substrate and dried with a hot air blower for 10 seconds.

The so-obtained pre-structure was cut in the coating direction into two square pieces (10 cm×10 cm) consisting of a first structure comprising a hardened coating on a PET substrate and a second structure comprising a hardened coating on a PET substrate. One of the two pieces was placed on the top of the other in such a way that both PET substrates faced the environment, and that the first hardened coating and second hardened coating were comprised between said PET substrates and were jointly visible from one side of assembly. The so-obtained assembly was fixed by scotch tapes, was inserted in between two pieces of carton paper and was laminated four times at 120° C. for 20 seconds (laminator: Laminator model 6000 described in U.S. Pat. No. 3,770,550).

The laminated structure obtained thereof was then sliced so as to obtain security threads having a width of 4 mm, said security threads exhibiting a first hardened coating having a width of 2 mm and a second hardened coating having a width of 2 mm, both stripes being visible from the same side of the security thread and exhibiting a visual impression of moving in opposite direction when the security thread is tilted.

1. A process for producing a security thread or stripe comprising a step of laminating a first structure comprising a transparent substrate and a first plurality of magnetic or magnetizable pigment particles, said pigment particles being dispersed in a first hardened coating and oriented so as to follow a convex curvature when viewed from the side carrying the first hardened coating, with a second structure comprising a transparent substrate and a second plurality of magnetic or magnetizable pigment particles, said pigment particles being dispersed in a second hardened coating and oriented so as to follow a convex curvature when viewed from the side carrying the second hardened coating,
so that the transparent substrates face the environment and that the first hardened coating and second hardened coating are comprised between the transparent substrates so as to form a laminated structure,
wherein the first hardened coating and the second hardened coating are adjacent to each other or are spaced apart,
wherein the first hardened coating and the second hardened coating are at least partially jointly visible from one side of the security thread or stripe, and
wherein the laminated structure comprises the first hardened coating comprising the first plurality of magnetic or magnetizable pigment particles having an orientation following a convex curvature when viewed from the side of the security thread or stripe where the first hardened coating and the second hardened coating are at least partially jointly visible and the second hardened coating comprising the second plurality of magnetic or magnetizable pigment particles having an orientation following a concave curvature when viewed from the side of the security thread or stripe where the first hardened coating and the second hardened coating are at least partially jointly visible so as to form a plural rolling bar effect.

2. The process according to claim 1, wherein the first structure and/or the second structure are independently prepared by a) a step of applying, preferably by a printing process selected from the group consisting of rotogravure, screen printing and flexography, on the transparent substrate a coating composition comprising a binder material and the plurality of magnetic or magnetizable pigment particles, b) exposing the coating composition in a first state to the magnetic field of a magnetic-field-generating device, and c) hardening the coating composition to a second state so as to fix the magnetic or magnetizable pigment particles in their adopted positions and orientations so as to obtain a hardened coating.

3. The process according to claim 1, wherein the first structure and the second structure are produced from a pre-structure prepared by a) a step of applying, preferably by a printing process selected from the group consisting of rotogravure, screen printing and flexography, on the transparent substrate a coating composition comprising a binder material and the plurality of magnetic or magnetizable pigment particles, b) exposing the coating composition in a first state to the magnetic field of a magnetic-field-generating device, and c) hardening the coating composition to a second state so as to fix the magnetic or magnetizable pigment particles in their adopted positions and orientations so as to obtain a hardened coating and d) cutting the pre-structure obtained under step c) so as to obtain the first structure and the second structure.

4. The process according to claim 2, wherein the exposing step b) is carried out by applying a magnetic orienting cylinder.

5. The process according to claim 2, wherein the applying step a) is carried out simultaneously with the step b) of exposing the coating composition to the magnetic field of a magnetic-field-generating device so as to orient the magnetic or magnetizable pigment particles.

6. The process according to claim 2, wherein the hardening step c) is carried out simultaneously with the step b) of exposing the coating to composition to the magnetic field of a magnetic-field-generating device so as to orient the magnetic or magnetizable pigment particles.

7. The process according to claim 2, wherein the hardening step c) is carried out by using hot air, radiation or by any combination thereof.

8. The process according to claim 1 further comprising a step of slicing the laminated structure.

9. The process according claim 1, wherein at least a part of the first plurality of magnetic or magnetizable pigment particles and/or at least a part of the second plurality of magnetic or magnetizable pigment particles is constituted by magnetic thin-film interference pigments, magnetic cholesteric liquid crystal pigments, interference coated pigments comprising one or more magnetic materials and mixtures thereof.

10. The process according to claim 9, wherein the magnetic thin-film interference pigments comprise pigments having a 5-layer Fabry-Perot absorber/dielectric/reflector/dielectric/absorber multilayer structure, a 6-layer Fabry-Perot absorber/dielectric/reflector/dielectric/absorber multilayer structure and/or 7-layer Fabry-Perot absorber/dielectric/reflector/dielectric/absorber multilayer structure.

11. The process according to claim 9, wherein the magnetic thin film magnetic interference pigments comprise pigments having a 7-layer Fabry-Perot absorber/dielectric/reflector/magnetic/reflector/dielectric/absorber multilayer, preferably pigments having a multilayer structure consisting of Cr/MgF2/Al/Ni/Al/MgF2/Cr.

12. The process according to claim 1, wherein the transparent substrate of the first structure and the transparent substrate of the second structure are independently made of one or more plastics or polymers.

13. The process according to claim 12, wherein the transparent substrate of the first structure and/or the transparent substrate of the second structure are metalized substrates.

14. The process according to claim 1 further comprising a step of applying one or more adhesive layers on the transparent substrate of the first structure and/or on the transparent substrate of the second structure.

15. A process for producing a security document comprising a security thread or stripe, said process comprising the steps of:
i) producing the security thread or stripe by the process recited in claim 1, and
ii) at least partially embedding in said security document the security thread or stripe obtained under step i) or a step of mounting the security thread or stripe obtained under step i) on the surface of the security document.

16. A security thread or stripe comprising a laminated structure, the laminated structure comprising a first structure and a second structure, the first and second structures each comprising a transparent substrate and a plurality of magnetic or magnetizable pigment particles, said pigment particles being dispersed in a hardened coating and oriented for exhibiting a rolling bar effect, wherein the transparent substrates face outwardly in the laminated structure and the hardened coatings of the first and second structures are comprised between the transparent substrates in the laminated structure, wherein the first or the second structure has a portion free of coating through which the underlying oriented magnetic or magnetizable pigment particles of the other of the first or the second structures can be viewed from one side of the security thread or stripe such that rolling bar effects provided by the oriented pigment particles of the first structure and the second structure are jointly visible from the one side of the security thread or stripe, the joint effect being that of rolling bars respectively provided by the first and second structures rolling in opposite directions when the security thread or stripe is tilted.

17. A security document comprising a security thread or stripe as recited in claim 16, wherein the security thread or stripe is at least partially embedded in said security document or the security thread or stripe is mounted on the surface of the security document.
